(19) United States
(12) Patent Application Publication
(10) Pub. No.: US 2006/0054657 A1
(43) Pub. Date: Mar. 16, 2006

(54) Method and apparatus for de-soldering integrated circuit devices

(76) Inventor: Thamarayoor R. Francis, Bangalore (IN)

Correspondence Address: TEXAS INSTRUMENTS INCORPORATED, P O BOX 655474, M/S 3999, DALLAS, TX, 75265, US

(21) Appl. No.: 10/942,284

(22) Filed: Sep. 16, 2004

(51) Int. Cl. B23K 1/00

(52) U.S. Cl. 228/19

(57) ABSTRACT

A technique to de-solder an integrated circuit device having one or more rows of solder balls underneath connected to a printed circuit board (PCB). In one example embodiment, this is accomplished by placing the PCB on a table surface such that the integrated circuit device is disposed across from the table surface. A heating element is then positioned between the underneath the integrated circuit device and the PCB such that the heating element is substantially in contact with a current row of solder balls. The one or more rows of solder balls are then conductively heated until solder reaches reflow temperature and sliced in a direction substantially parallel to the table surface using the heating element on a row-by-row basis to de-solder the integrated circuit device from the PCB.

### TECHNICAL FIELD OF THE INVENTION

The present invention relates generally to removal of integrated circuit devices from printed circuit boards (PCBs), and more particularly relates to de-soldering of integrated circuit devices from the PCBs.

### BACKGROUND OF THE INVENTION

Many electronic systems include a printed circuit board (PCB) with several integrated circuit devices connected to the PCB. Frequently, these integrated circuit devices are connected to the PCB by solder. For example, integrated circuit devices, such as ball grid arrays (BGA) are utilized in a circuit along with other electronic components that are connected to the PCB by solder. BGAs typically include at least one ball of solder arranged between the integrated circuit device and the printed circuit board at each contact so as to electrically connect the integrated circuit device to the circuit board.

During the process of attaching such integrated circuit devices to the PCB, the connections might not be successfully made between the integrated circuit device and the circuit board by the solder balls. Whether failures of connections occur prior to or during operation of a circuit board, which can include an integrated circuit device, such as a BGA, it is necessary to remove the integrated circuit device from the PCB.

Conventional techniques use hot air to de-solder integrated circuit devices, such as the BGA, from circuit boards. Generally, these techniques direct a jet of hot air at a component to melt the solder which connects the component leads to the circuit board. However, these known techniques have a tendency to melt or otherwise damage the component being removed, the surrounding components, and/or the PCB due to overheating and uncontrolled hot air.

In addition, these techniques require expensive tools and apparatus to de-solder the integrated circuit devices. Further, these techniques require a different tool to accommodate varying component sizes and types of integrated circuit packages. Furthermore, these techniques can require sophisticated apparatus to position the de-soldering head over the integrated circuit devices. Also, the apparatus required to use these techniques can require highly skilled operators to use them. These techniques can also require complex temperature profiling to melt the solder without damaging the component being removed and/or surrounding components connected to the PCB.

### SUMMARY OF THE INVENTION

According to an aspect of the present invention there is provided a method for de-soldering an integrated circuit device having multiple rows of solder balls connected to a printed circuit board. The method includes positioning a heating element between the integrated circuit device and the PCB such that the heating element is in substantial contact with a current row of solder balls in the multiple rows of solder balls. The current row of solder balls are then conductively heated using the heating element until solder in the current row of solder balls reaches a reflow temperature. The current row of solder balls are then sliced using the heating element upon the solder reaching the reflow temperature to de-solder the current row of solder balls from the PCB. The above process is repeated until all of the rows of solder balls in the multiple rows of solder balls are sliced using the heating element to de-solder the integrated circuit device from the PCB.

According to another aspect of the present invention there is provided a de-soldering tool for removing an integrated circuit device connected to a substrate. The integrated circuit device has one or more terminals underneath that are soldered to the substrate. The apparatus includes a heating element. The heating element is held in a de-soldering head such that heating element can be disposed between the integrated circuit device and the substrate and such that the heating element substantially contacts the one or more soldered terminals connecting the integrated circuit device to the substrate. The de-soldering tool further includes a temperature sensor to monitor the temperature of the heating element so that the temperature of the heating element can be controlled to reflow the solder in the soldered one or more terminals to de-solder the integrated circuit device from the substrate.

According to another aspect of the present invention there is provided a de-soldering tool for removing an integrated circuit device having one or more rows of solder balls underneath connecting to a substrate having electronic components. The apparatus includes a heating element. The heating element is held in a de-soldering tool head such that the heating element can be disposed to be substantially in contact with a current row of solder balls in the one or more rows of solder balls without interfering with the surrounding electronic components on the substrate. The de-soldering tool also includes a temperature sensor for sensing the temperature of the heating element so that the temperature of the heating element can be controlled to reflow the solder and de-solder the current row of solder balls from the substrate.

According to another aspect of the present invention there is provided an apparatus for de-soldering an integrated circuit device having a grid of solder balls underneath connecting to a PCB assembly. The grid of solder balls includes multiple rows of solder balls. The apparatus includes a substrate base. The substrate base has a substantially flat surface to hold the PCB assembly such that the integrated circuit device is disposed across from the substantially flat surface of the substrate base. The apparatus further includes a spring loaded de-soldering head movably coupled to the substrate base. The spring loaded de-soldering head is capable of moving and applying force in a direction substantially parallel to the substantially flat surface. The apparatus also includes a de-soldering tool coupled to the spring loaded de-soldering head. The de-soldering tool includes a de-soldering fixture. A heating element is coupled to the de-soldering fixture such that the heating element can be inserted underneath the integrated circuit device. A temperature controller is coupled to the heating element for controlling the temperature of the heating element such that each of the multiple rows of solder balls can be heated to reflow the solder on a row-by-row basis. The spring loaded de-soldering head is then moved in a direction that is substantially parallel to the substantially flat surface to slice through each of the multiple rows of solder balls to de-solder the integrated circuit device from the PCB assembly on a row-by-row basis upon the solder in each row reaching the reflow temperature.

### BRIEF DESCRIPTION OF THE DRAWINGS

FIG. 1 is a perspective view of a de-soldering tool according to an embodiment of the present invention.

FIG. 2 is a perspective view of a de-soldering apparatus according to an embodiment of the present invention.

FIG. 3 is a flowchart illustrating an example method of de-soldering using the de-soldering apparatus of FIG. 2.

FIGS. 4 and 5 are front elevations illustrating de-soldering of small outline packages (SOPs) according to an embodiment of the present invention.

### DETAILED DESCRIPTION OF THE INVENTION

In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The terms “substrate” and “printed circuit board” are used interchangeably throughout the document.

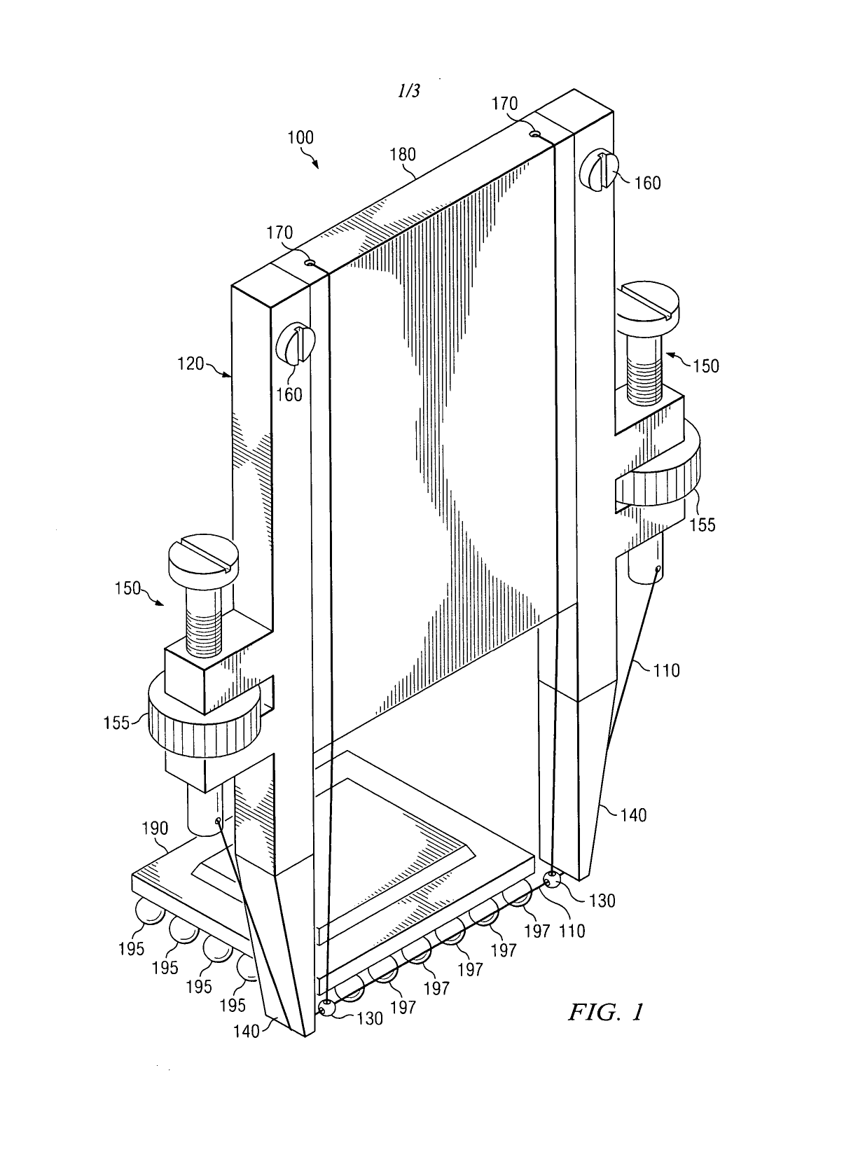

FIG. 1 illustrates an example of a de-soldering tool 100 according to an embodiment of the present invention. As shown in FIG. 1, the de-soldering tool 100 includes a heating element 110, a de-soldering tool head 120 to hold the heating element 110, and a temperature sensor 130 to sense the temperature of the heating element 110.

As shown in FIG. 1, the de-soldering tool head 120 includes a pair of legs 140 to hold the heating element 110 and a pair of associated tension adjusting mechanisms 150 to adjust the tension of the heating element 110. The tension of the heating element 110 can be adjusted by using a spring or other such devices that can provide the necessary to tension to the heating element 110. Also as shown in FIG. 1, the de-soldering tool head 120 includes electrical and temperature sensor leads 160 and 170, respectively, to connect to a power source and a temperature controller, respectively. Furthermore as shown in FIG. 1, the de-soldering tool head 120 includes an insulator 180 that is disposed between the pair of legs 140.

FIG. 1 also shows an integrated circuit device 190, such as a ball grid array (BGA) including a grid of solder balls 195 attached underneath the integrated circuit device 190. As shown in FIG. 1, the grid of solder balls 195 includes one or more rows of solder balls. It can be envisioned that the integrated circuit device 190 can also have other IC (integrated circuit) packages, other than the BGA package 190 shown in FIG. 1, to connect to a substrate, such as a printed circuit board (PCB). For example, the IC package can be a gull-wing lead package, J lead package, or any other surface mount device package to connect to the substrate.

The heating element 110 can be a nichrome alloy wire or any other resistance alloy materials capable of conductively applying heat to the one or more rows of solder balls 195 and raise the temperature of the solder to a reflow temperature of about 183° C. to about 250° C. for a solder alloy composition of 37% Tin and 63% Lead. The reflow temperature can be different for a different alloy composition. In these embodiments, the nichrome alloy wire can have a diameter in the range of about 0.2 millimeter to 1 millimeter. The heating element 110 may be a ribbon type of heating element having a thickness in the range of about 0.2 to 1 millimeter. It can be envisioned that the diameter and the thickness of the heating element 110 can vary depending on the type of resistance alloy material used for the heating element 110. Also, the diameter and the thickness of the heating element 110 can vary depending on the thickness of the solder balls or solder joints to be de-soldered from the substrate.

As shown in FIG. 1, the heating element 110 is held in the de-soldering tool head 120 such that the heating element 110 can be disposed to substantially contact a current row of solder balls 197 in the one or more rows of solder balls 195 of the BGA 190. In these embodiments, the pair of legs 140 is disposed in the de-soldering tool head 120, such that each of the pair of legs 140 is across from each other.

Also as shown in FIG. 1, each of the pair of tension adjusting mechanisms 150 are disposed such that they are across from each other and are substantially in close proximity to associated each of the pair of legs 140. As shown in FIG. 1, the heating element 110 is coupled to the pair of tension adjusting mechanisms 150. Also it can be seen in FIG. 1, that each of the pair of tension adjusting mechanisms can be used to adjust individually to provide a sufficient tension to the heating element 110 to de-solder the one or more rows of solder balls 195. In the embodiment shown in FIG. 1, the pair of tension adjusting mechanisms 150 are screw type mechanisms including a knobs 155. As shown in FIG. 1, each of the knobs 155 can be individually turned to adjust the tension in the heating element 110. It can be envisioned that the adjustment of the tension to the heating element 110 can be achieved by using a spring type mechanism or other such mechanisms that can provide the necessary tension to the heating element 110 for de-soldering the one or more rows of solder balls 195. The heating element 110 can be coupled to each of the pair of tension adjusting mechanisms 150 by using metal joining processes, such as brazing, welding, spot welding, hooking, clamping, and so on.

It can be envisioned that the de-soldering tool head 120 including the pair of legs 140 can be designed to accommodate varying sizes of integrated circuit devices, thus reducing the need for requiring multiple de-soldering too heads. It can be seen in FIG. 1 that the heating element 110 is held between the pair of legs 140 by stretching the heating element 110 using the pair of tension adjusting mechanisms 150. Each of the knobs 155 can be individually turned to provide the necessary to tension to the heating element 110 so that the heating element 110 can slice through the current row of solder balls 197 upon the solder reaching the reflow temperature. The temperature of the heating element 110 can be controlled such that the heating element 110 can reflow the solder locally to avoid any reconnecting of the de-soldered solder joints after slicing through the current row of solder balls. Generally, the solder used in such solder balls and/or solder joints are of eutectic type of alloy that melts and solidifies at or around a specific temperature.

The temperature sensor 130 can be a thermocouple or any other sensor capable of sensing the temperature of the heating element 110 so that the temperature of the heating element 110 can be controlled to reflow the solder and de-solder the current row of solder balls 197 in the one or more rows of solder balls 195. In some embodiments, the temperature sensor 130 can be based on monitoring a change in the resistance of the heating element 110. As shown in FIG. 1, the thermocouple 130 can be disposed to be substantially in contact with the heating element 110 at or near each of the pair of legs 140.

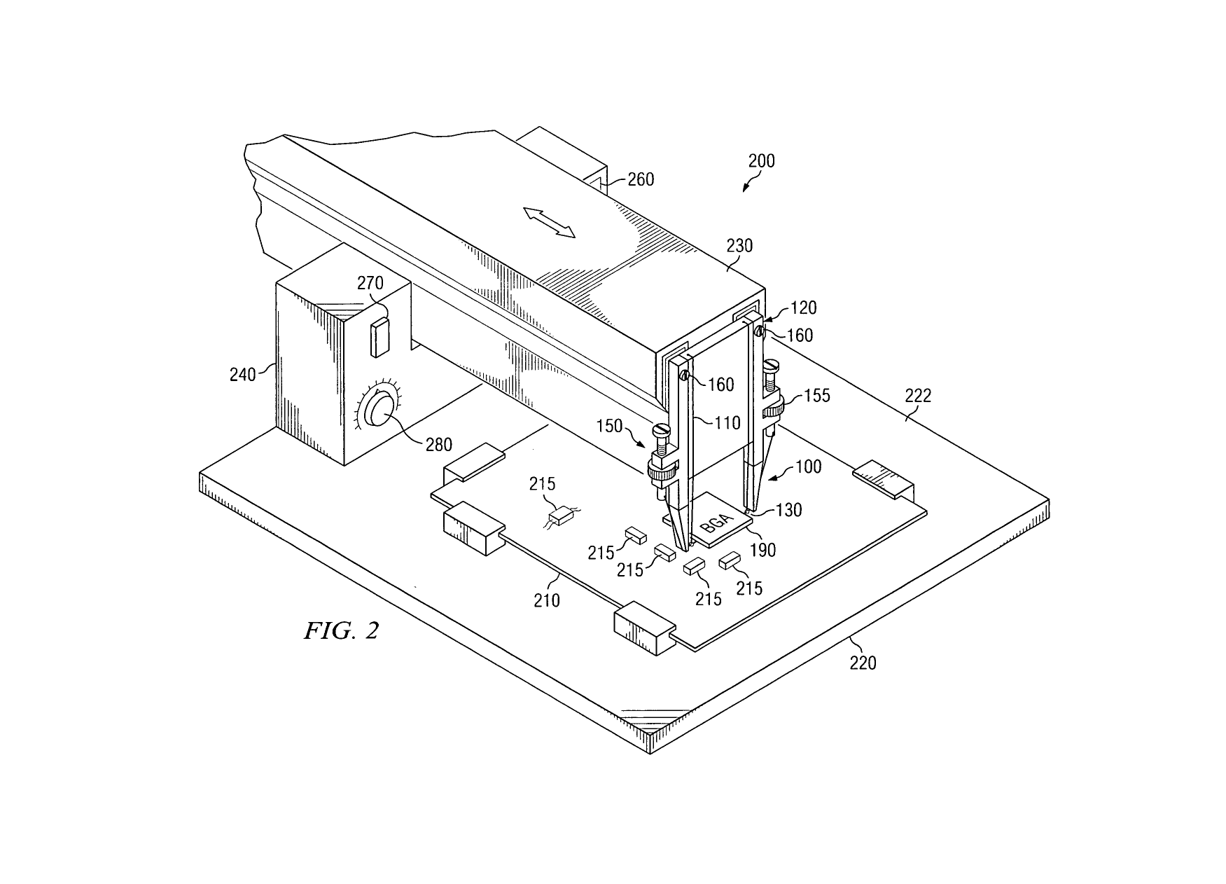

FIG. 2 illustrates an example apparatus 200 for de-soldering an integrated circuit device according to an embodiment of the present invention. As shown in FIG. 2, the de-soldering apparatus 200 includes the de-soldering tool 100 shown in FIG. 1, electronic components 215 and the BGA 190 connected to the PCB 210, a substrate base 220, a spring loaded de-soldering head 230, and a column 240. As shown in FIG. 2, the substrate base 220 has a substantially flat surface 222. Further as shown in FIG. 2, the spring loaded de-soldering head 230 is coupled to the de-soldering tool 100. Also shown in FIG. 2, are a power switch 270 and a rotary switch 280 to set a desired temperature at the point of contact between the heating element 110 and the solder balls and/or solder joints to be de-soldered.

Also as shown in FIG. 2, the spring loaded de-soldering head 230 is movably coupled to the column 240. In these embodiments, the spring loaded de-soldering head 230 is capable of moving in a direction that is substantially parallel to the substantially flat surface 222. The column 240 extends upwardly from the substrate base 220. Further as shown in FIG. 2, a temperature controller 260 is coupled to the heating element 110 via the power terminals 160. As shown in FIG. 2, the thermal sensor 130 is disposed substantially at the heating element 110 to measure the temperature at a point of de-soldering. Also as shown in FIG. 2, the thermal sensor 130 is coupled to the temperature controller 260 via the thermal sensor terminals 170 (shown in FIG. 1).

For example, as illustrated in FIG. 2, the spring loaded de-soldering head 230 provides a sufficient force to move the heating element 110 in the direction that is substantially parallel to the substantially flat surface 222 upon the solder reaching a reflow temperature to slice through each of the multiple rows of solder balls 195 (shown in FIG. 1) to de-solder the integrated circuit device 190 from the PCB assembly 210. In operation, the heating element 110 is disposed between the integrated circuit device 190 and the PCB assembly 210 such that the heating element 110 is substantially in contact with one or more soldered terminals. For example, as shown in FIG. 2 the integrated circuit device 190 is a BGA having multiple rows of solder balls 195 (shown in FIG. 1) underneath the BGA that is connected to the PCB assembly 210. In this embodiment, the heating element 110 is disposed between the underneath the BGA 190 and the PCB assembly 210 such that the heating element 110 is substantially in contact with a current row of solder balls 197.

The current row of solder balls 197 (shown in FIG. 1) that are substantially in contact with the heating element 110 are then conductively heated by applying power to the heating element 110 via the temperature controller 260 until the solder in the current row of solder balls 197 (shown in FIG. 1) reaches a reflow temperature. The temperature during heating of the current row of solder balls 197 (shown in FIG. 1) is controlled using the temperature sensor 130 that is coupled to the heating element 110 and the temperature controller 260.

The current row of solder balls 197 (shown in FIG. 1) are then de-soldered by moving the spring loaded de-soldering head 230 such that the heating element 110 slices through the current row of solder balls 197 (shown in FIG. 1) to de-solder the current row of solder balls 197 (shown in FIG. 1) from the PCB 210. The temperature of the heating element 110 can be controlled using the temperature controller 260 such that the heating element 110 reflows the solder locally to avoid any reconnecting of the de-soldered solder joints after slicing through the current row of solder balls 197 (shown in FIG. 1). Generally, the solder used in such solder balls and/or solder joints are of eutectic type of alloy that melts and solidifies at or around a specific solidifying temperature.

In some embodiments, the spring loaded de-soldering head 230 can be automated to move in a direction that is substantially parallel to the substantially flat surface 222 to slice the current row of solder balls 197 (shown in FIG. 1) to de-solder the current row of solder balls 197 (shown in FIG. 1) from the PCB assembly 210 once the solder reaches the reflow temperature. For example, as shown in FIG. 2, the automatic movement of the spring loaded de-soldering head 230 can be obtained using a computer controlled mechanism. In these embodiments, the spring loaded de-soldering head 230 is designed to provide a necessary force to move the de-soldering tool 100 to slice the reflowed solder to de-solder the one or more solder joints to remove the integrated circuit device 190 from the PCB assembly 210. The above-described process repeats itself on a row-by-row basis until all the rows of solder balls in the multiple row of solder balls 195 (shown in FIG. 1) are de-soldered to remove the BGA 190 from the PCB assembly 210.

It can be envisioned that the integrated circuit device may have terminals, other than the multiple row of solder balls shown in FIG. 1, to connect to the PCB assembly 210, such as the gull-wing type leads, J type leads, and so on. In these embodiments, the heating element 110 used can be a wire type of heating element or a ribbon type of heating element having a diameter or thickness, respectively, in the range of about 0.2 to 1 millimeter. The diameter and the thickness of the heating element 110 can vary depending on the type of resistance alloy material used for the heating element 110. Also, the diameter and the thickness of the heating element 110 can vary depending on the thickness of the solder balls or solder joints to be de-soldered from the substrate.

It can also be envisioned that in these embodiments, the wire type or the ribbon type of heating elements can be positioned substantially close to the one or more of these types of leads using the apparatus, such as the one shown in FIG. 2, to heat and reflow the solder joints to de-solder such integrated circuit devices from the PCB assembly 210.

FIG. 3 is a flowchart illustrating an example embodiment of a method 300 of de-soldering an integrated circuit device having multiple rows of solder balls connected to a PCB. At 310, the method 300 in this example embodiment places a PCB having an integrated circuit device, which is surrounded by other electronic components on a table having a substantially flat surface The PCB is placed on the substantially flat surface such that the integrated circuit device and the surrounding electronic components are disposed across from the substantially flat surface. In these embodiments, the PCB can be held in a position on the substantially flat surface by clamping the PCB to the table to prevent movement of the PCB during the de-soldering of the integrated circuit device from the PCB.

At 320, tension of a heating element held in a de-soldering tool head is adjusted to provide sufficient stiffness to the heating element to slice through the multiple rows of solder balls on a row-by-row basis upon solder reaching a reflow temperature. At 330, the heating element is positioned between the integrated circuit device and the PCB such that the heating element is substantially in contact with a current row of solder balls and does not interfere with the surrounding electronic components.

At 340, the current row of solder balls are heated conductively by applying power to the heating element. The heat is conductively applied such that the temperature of the current row of solder balls can rise to a reflow temperature of about 183° C. to about 250° C. for a eutectic solder alloy composition of 37% Tin and 63% Lead. The temperature range to reflow the solder can be different for a lead free solder or other solder alloys used in the terminals and solder joints. At 350, the current row of solder balls are sliced by moving the heating element in a direction that is substantially parallel to the substantially flat surface upon the solder reaching the reflow temperature to de-solder the current row of solder balls from the PCB.

At 360, the method 300 determines whether there is another row of solder balls in the multiple rows of solder balls that needs to be de-soldered. Based on the determination at 360, the method goes to act 330 and repeats acts 330-360 to de-solder a next row of solder balls, if there is another row of solder balls that needs to be de-soldered from the PCB. Based on the determination at 360, the method goes to act 370, if there are no other rows of solder balls that need to be de-soldered from the PCB. At 370, the method 300 stops the de-soldering of the multiple rows of solder balls and removes the integrated circuit device from the PCB. The above-described steps, to de-solder the integrated circuit device from the PCB, are described in more detail with reference to FIGS. 1 and 2.

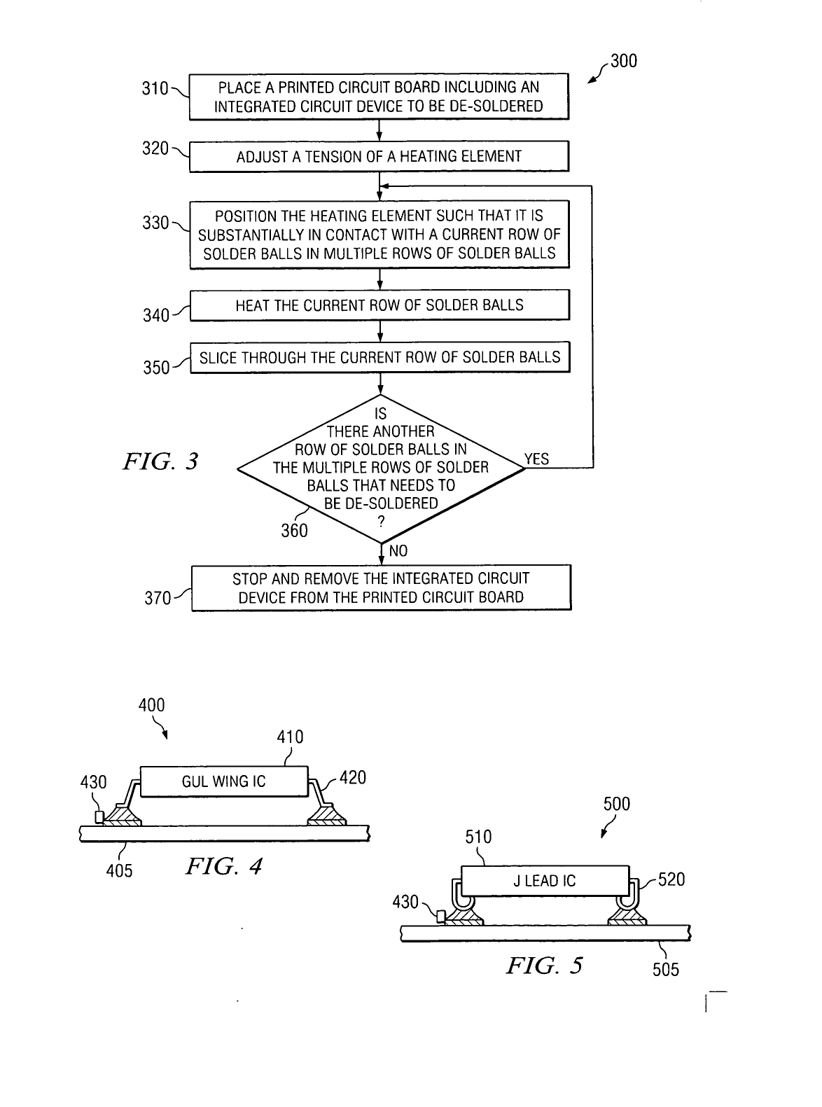

FIGS. 4 and 5 illustrate example small outline packages (SOPs) 400 and 500, respectively, which can be de-soldered using an embodiment of the present invention. As shown in FIG. 4, the SOP 400 is a gull-wing IC package 410 that is connected to a substrate 405 via the gull-wing leads 420. Also, shown in FIG. 4 is a ribbon type heating element 430 that is placed substantially close to the gull-wing leads 420. Similarly, FIG. 5 shows the SOP 500, which is a J lead IC package 510 that is connected to a substrate 505 via the J leads 520. Also, shown in FIG. 5 is the ribbon type 430 heating element that is placed substantially close to the J leads 520. It can be envisioned that the heating element 430 can be heated using the apparatus 200 shown in FIG. 2 to de-solder the gull-wing package 400 and the J lead IC package 500 from the substrate 405, and 505, respectively. It can also be envisioned that other surface mount IC packages, similar to the ones shown in FIGS. 4 and 5, connected to a substrate can be de-soldered from the substrate using the process described with reference to the above described FIGS. 1-3.

The above-described methods and apparatus provide various techniques to de-solder an integrated circuit device attached to a PCB assembly. It is to be understood that the above description is intended to be illustrative, and not restrictive. Many other embodiments will be apparent to those of skill in the art upon reviewing the above description. The scope of the subject matter should, therefore, be determined with reference to the following claims, along with the full scope of equivalents to which such claims are entitled.

As shown herein, the present invention can be implemented in a number of different embodiments, including various methods, an apparatus, and a system. Other embodiments will be readily apparent to those of ordinary skill in the art. The elements, algorithms, and sequence of operations can all be varied to suit particular requirements. The operations described above with respect to the method illustrated in FIG. 3 can be performed in a different order from those shown and described herein.

FIGS. 1-5 are merely representational and are not drawn to scale. Certain proportions thereof may be exaggerated, while others may be minimized. FIGS. 1-5 illustrate various embodiments of the invention that can be understood and appropriately carried out by those of ordinary skill in the art.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing detailed description of the embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of the embodiments of the invention, with each claim standing on its own as a separate preferred embodiment.

The above description is intended to be illustrative, and not restrictive. Many other embodiments will be apparent to those skilled in the art. The scope of the invention should therefore be determined by the appended claims, along with the full scope of equivalents to which such claims are entitled.

1. A de-soldering tool for removing an integrated circuit device connected to a substrate, comprising:
a heating element;
a de-soldering tool head to hold the heating element such that the heating element can be disposed between the integrated circuit device and the substrate, and wherein the integrated circuit device has one or more terminals, wherein the one or more terminals are soldered to the substrate, and wherein the disposed heating element is substantially in contact with the one or more soldered terminals; and
a temperature sensor coupled to the heating element for sensing the temperature of the heating element so that the temperature of the heating element can be controlled to reflow solder and de-solder the one or more terminals from the substrate.

2. The de-soldering tool of claim 1, wherein the heating element is a nichrome alloy wire having a diameter in the range of about 0.5 millimeter to 2 millimeters.

3. The de-soldering tool of claim 2, wherein the de-soldering tool head comprises a pair of legs to hold the nichrome alloy wire such that the heating element along with the de-soldering tool head can be moved substantially parallel to the substrate without interfering with adjacent electronic components on the substrate.

4. The de-soldering tool of claim 3, wherein the de-soldering tool head comprises a pair of tension adjusting mechanisms, wherein each of the pair of tension adjusting mechanisms is disposed across from each other and substantially in close proximity to the pair of legs, wherein the heating element is coupled to the pair of tension adjusting mechanisms such that each of the pair of tension adjusting mechanisms can be adjusted individually to stretch the nichrome alloy wire to provide a sufficient tension to de-solder the integrated circuit device from the substrate by slicing the soldered one or more terminals upon the solder reaching the reflow temperature.

5. The de-soldering tool of claim 1, wherein the temperature sensor is a thermocouple.

6. The de-soldering tool of claim 1, wherein the temperature sensor comprise measuring change in resistance in the heating element to sense and control the temperature heating element.

7. A de-soldering tool for removing an integrated circuit device having one or more rows of solder balls underneath connecting to a substrate having electronic components, comprising:
a heating element;
a de-soldering tool head to hold the heating element such that the heating element can be disposed to be substantially in contact with a current row of solder balls in the one or more rows of solder balls without interfering with adjacent electronic components on the substrate; and
a temperature sensor coupled to the heating element for sensing the temperature of the heating element so that the temperature of the heating element can be controlled to reflow solder and de-solder the current row of solder balls from the substrate.

8. The de-soldering tool of claim 7, wherein the heating element is a nichrome alloy wire having a diameter in the range of about 0.5 millimeter to 2 millimeters.

9 The de-soldering tool of claim 8 wherein the de-soldering tool head comprises a pair of legs to hold the nichrome alloy wire such that the heating element along with the de-soldering tool head can be moved substantially parallel to the substrate without interfering with the electronic components on the substrate, wherein the pair of legs are disposed in the de-soldering tool head such that each of the pair of legs is disposed across from each other.

10. The-soldering tool of claim 8, wherein the de-soldering tool head comprises a pair of tension adjusting mechanisms, wherein each of the pair of tension adjusting mechanisms is disposed across from each other and substantially in close proximity to the pair of legs, wherein the heating element is coupled to the pair of tension adjusting mechanisms such that each of the pair of tension adjusting mechanisms can be adjusted individually to stretch the nichrome alloy wire to provide a sufficient tension to de-solder the one or more rows of solder balls.

11. The de-soldering tool of claim 9, wherein the nichrome alloy wire is coupled to each of the tension adjusting mechanisms by using a process selected from the group consisting of brazing, welding, spot welding, hooking, and clamping.

12. The de-soldering tool of claim 7, wherein the temperature sensor is a thermocouple.

13. An apparatus for de-soldering an integrated circuit device having a grid of solder balls underneath connecting to a printed circuit board (PCB) having electronic components, wherein the grid of solder balls has multiple rows of solder balls, the apparatus comprising:
a substrate base, wherein the substrate base has a substantially flat surface to hold the PCB assembly such that the integrated circuit device can be disposed across from the substantially flat surface of the substrate base;
a column coupled to the base, wherein the column extends upwardly from the base;
a spring loaded de-soldering head movably coupled to the column, wherein the spring loaded de-soldering head capable of moving in a direction substantially parallel to the substantially flat surface; and
a de-soldering tool coupled to the spring loaded de-soldering head, comprising:
a de-soldering fixture;
an heating element coupled to the de-soldering fixture such that the heating element can be inserted between the underneath the integrated circuit device and the PCB assembly; and
a temperature controller coupled to the heating element for controlling the temperature of the heating element such that each of the multiple rows of solder balls can be heated to reflow solder in the solder balls on a row-by-row basis, wherein the spring loaded de-soldering head is moved in the direction substantially parallel to the substantially flat surface to slice through each of the multiple rows of solder balls on a row-by-row basis upon the solder reaching the reflow temperature.

14. The apparatus of claim 13, wherein the integrated circuit device comprises an IC package selected from the group consisting of a ball grid array (BGA), a J lead IC, a gull-wing IC, and a surface mount IC.

15. The apparatus of claim 13, wherein the heating element comprises a nichrome alloy wire.

16. The apparatus of claim 13, wherein the de-soldering fixture comprises:
a plurality of legs to hold the nichrome alloy wire such that the heating element along with the de-soldering tool fixture and the spring loaded de-soldering head can be moved substantially parallel to the substantially flat surface without interfering with the electronic components on the PCB assembly, wherein the plurality of legs holding the nichrome alloy wire capable of accommodating varying sizes of integrated circuit devices, and wherein each of the plurality of legs are disposed across from each other.

17. The apparatus of claim 16, wherein the de-soldering tool fixture comprises:
a pair of tension adjusting mechanisms that are disposed across from each other and substantially in close proximity to the plurality of legs, wherein the heating element is coupled to each of the pair of tension adjusting mechanisms such that each of the pair of tension adjusting mechanisms can be adjusted independently of the other to provide a necessary tension to the nichrome alloy wire.

18. The apparatus of claim 13, wherein the spring loaded de-soldering head is configured to provide sufficient force to move the de-soldering tool fixture in a direction that is substantially parallel to the substantially flat surface upon the solder reaching the reflow temperature in each of the multiple rows of solder balls.

19. The apparatus of claim 13, wherein the temperature controller comprises:
a temperature sensor coupled to the heating element; and
a temperature control circuit coupled to the temperature sensor for turning the heating element on and off in response to information provided by the temperature sensor.

20. The apparatus of claim 19, wherein the temperature sensor is substantially disposed at the heating element to measure the temperature at a point of de-soldering.

21. A method comprising:
positioning a heating element between an integrated circuit device and a PCB, wherein the integrated circuit device having multiple rows of solder balls underneath connecting to the PCB, wherein the PCB having electronic components, and wherein the heating element is substantially in contact with a current row of solder balls in the multiple rows of solder balls;
heating the current row of solder balls conductively using the heating element until solder in the current row of solder balls reaches a reflow temperature; and
slicing through the current row of solder balls by moving the heating element in a direction substantially parallel to the substantially flat surface upon the solder reaching the reflow temperature to de-solder the current row of solder balls.

22. The method of claim 21, further comprising:
determining whether there is another row of outer exposed solder balls in the multiple rows of solder balls that needs to be de-soldered;
if so, then repeating the above positioning, heating, and slicing steps to de-solder a next row of outer exposed solder balls; and
if not, then stopping the de-soldering of the integrated circuit device and removing the de-soldered integrated circuit device from the PCB.

23. The method of claim 21, further comprising:
placing the PCB having the integrated circuit device and the electronic components on a table having a substantially flat surface, wherein the integrated circuit device and the electronic components are disposed across from the substantially flat surface.

24. The method of claim 21, wherein the heat applied by the heating element is sufficient to raise the temperature of the solder balls to a reflow temperature of about 183° C. to about 250° C.

25. The method of claim 21, wherein, in de-soldering the integrated circuit device, the integrated circuit device is a BGA.

26. The method of claim 21, further comprising:
adjusting a tension of the heating element to provide a sufficient stiffness to the heating element to heat and slice through each of the multiple rows of solder balls on a row-by-row basis upon solder reaching a reflow temperature to de-solder the integrated circuit device from the PCB.
